(19) United States
(12) Patent Application Publication
(10) Pub. No.: US 2010/0119674 A1
(43) Pub. Date: May 13, 2010

(54) TEA PRESS

(75) Inventors: Matthew Frank, Seattle, WA (US); Ted Hurtado, Seattle, WA (US)

Correspondence Address: Karr Tuttle Campbell;ATTN: PRIYA SINHA CLOUTIER, 1201 Third Ave., Ste 2900, Seattle, WA, 98101, US

(73) Assignee: ICI USA, LLC, Seattle, WA (US)

(21) Appl. No.: 12/268,184

(22) Filed: Nov. 10, 2008

(51) Int. Cl. A47J 31/38

(52) U.S. Cl. 426/435; 99/302 P

(57) ABSTRACT

The purpose of the current invention, the Tea Press, is to provide the user with a beverage infuser that can be used away from a kitchen. It is compact enough to be carried in a purse or bag and has a location to store loose tea. After using the Tea Press, the tea can be quickly dried and stored for future use or disposal. The Tea Press also allows the user to determine the strength of his tea by allowing him to determine how much tea is placed within the infuser or, in the alternative, allows the user to brew volumes of greater than one cup of tea at one time.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The present invention relates generally to an infuser for brewing beverages, and more particularly, to an infuser for making teas, coffees, and other brewed beverages. Over the centuries, humans have made drinks by infusing teas into liquid. Tea is defined as tea leaves, spices, herbs, berries, beans, or a combination thereof.

Traditionally, to make a cup or pot of tea, tea is placed into a tea cup or tea pot, and hot water is poured over the tea. The tea is usually removed from the hot water before it is served.

Before the advent of tea bags, the tea was removed from the hot water by filtering. Sometimes an infuser would be used. A tea infuser, also known as a tea ball or tea egg, is a device in which loose tea is placed for brewing. The tea infuser gained popularity in first half the 19th century. All three methods of brewing tea have drawbacks.

The tea bag has a pre-measured amount of tea, predetermining the strength of tea. Additionally, bagging tea increases the cost of tea; tea consumers pay for the tea and the labor and material cost to bag the tea. Using a tea filter or infuser resolves these issues but creates others. For example, filters and tea infusers are difficult to use away from a home or restaurant because loose tea would need to be carried for use. This is a mess waiting to happen in a purse or car.

Finally, all three methods (tea bag, filter, and infuser) of brewing tea are messy because once removed from liquid the tea bag, filter, or infuser drips the liquid. The user must find a place to put or dispose the tea bag, filter or infuser. And, although the tea may have been reused for another cup or pot of tea, such reuse becomes impossible because there is no way to store the remaining tea.

The purpose of the current invention, the Tea Press, is to provide the user with a beverage infuser that can be used away from a kitchen. It is compact enough to be carried in a purse or bag and has a location to store loose tea. After using the Tea Press, the tea can be quickly dried and stored for future use or disposal. The Tea Press also allows the user to determine the strength of his tea by allowing him to determine how much tea is placed within the tea press or, in the alternative, allows the user to brew volumes of greater than one cup of tea at one time.

### BRIEF SUMMARY OF THE INVENTION

The purpose of the current invention, the Tea Press, is to provide the user with a beverage infuser that can be used away from a kitchen. It is compact enough to be carried in a purse or bag and has a location to store loose tea. After using the Tea Press, the tea can be quickly dried and stored for future use or disposal. The Tea Press also allows the user to determine the strength of his tea by allowing him to determine how much tea is placed within the infuser or, in the alternative, allows the user to brew volumes of greater than one cup of tea at one time.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an elevation view of the Tea Press in its storage position;

FIG. 2 is an elevation view of the syringe;

FIG. 3 is an expanded view of the barrel and drip sheath;

FIG. 4 is an expanded view of the plunger and the cap;

FIG. 5 is a bottom elevation view of the cap;

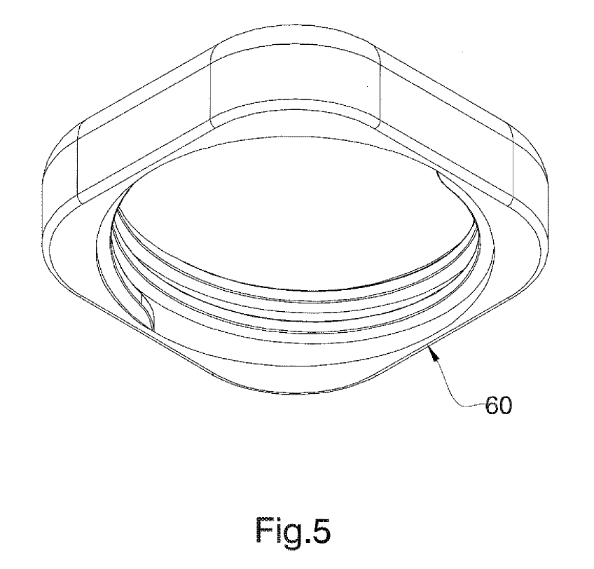

FIG. 6 is an elevation view of the bottom of the sheath;

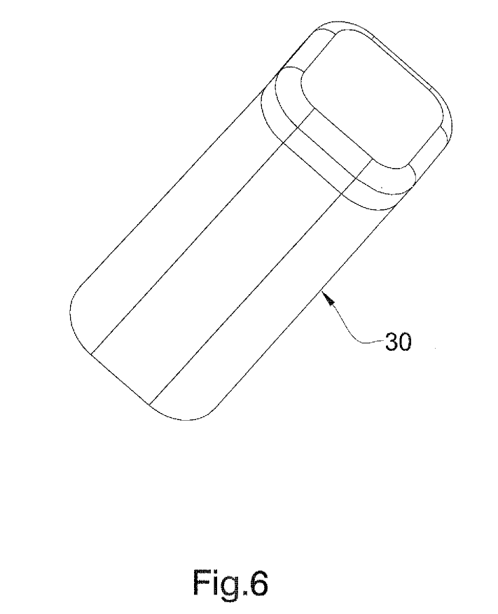

FIG. 7 is an exploded view end the closed end of the plunger.

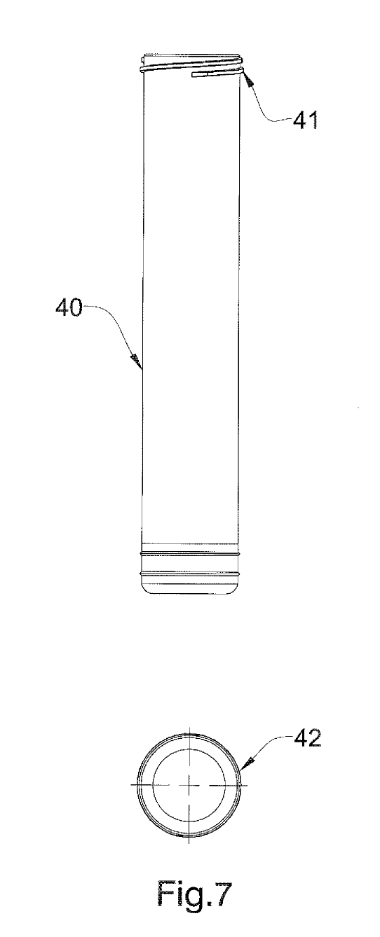

### DETAILED DESCRIPTION OF THE INVENTION

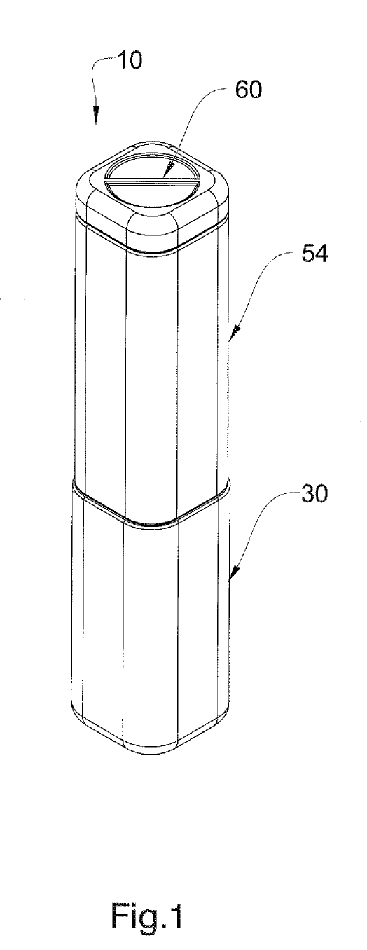

Referring to FIG. 1, the present invention, a Tea Press (“press”) 10, is described more fully hereinafter with reference to the accompanying drawings, in which preferred embodiments of the invention are shown. This invention may, however, be embodied in many different forms and should not be construed as limited to the embodiments set for herein; rather, these embodiments are provided so that this disclosure will be thorough and complete and will fully convey the scope of the invention to those skilled in the art

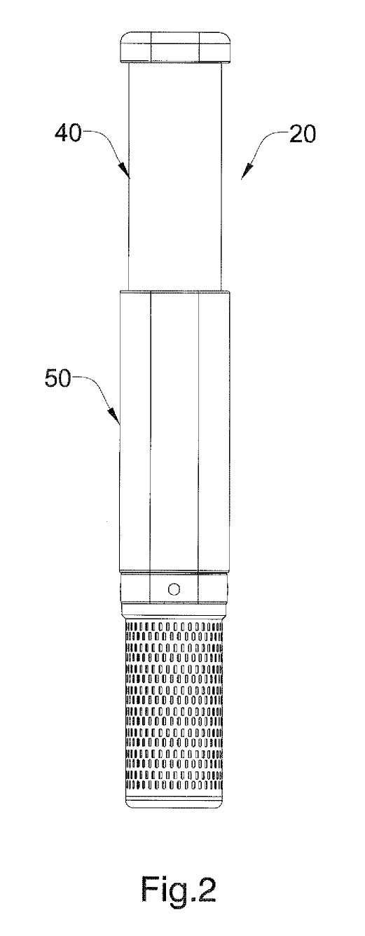

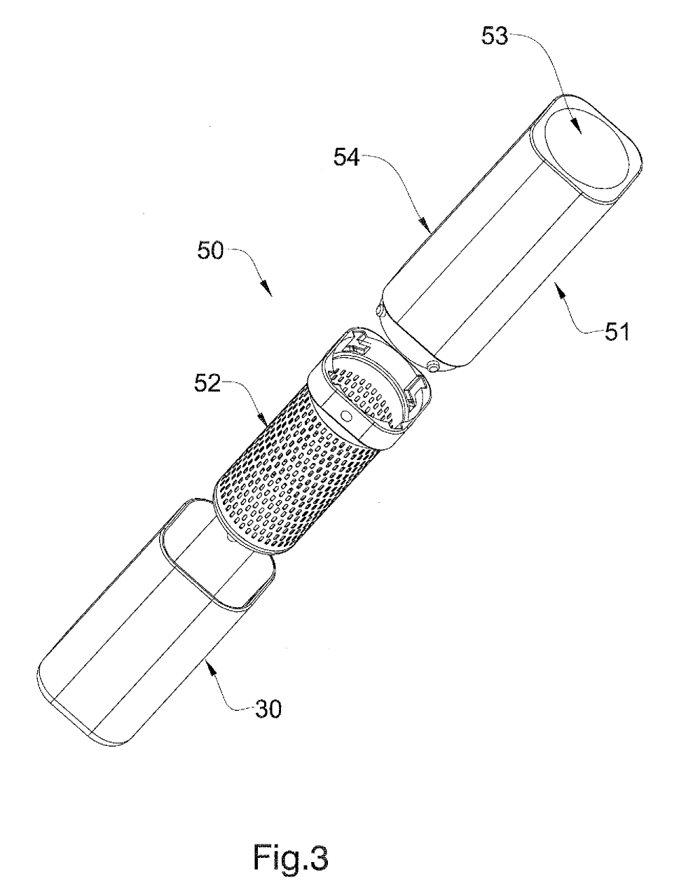

Referring to FIGS. 1, 2 and 3, the press 10 comprises a syringe 20, a drip sheath 30, and a cap 60. The syringe 20 is a simple piston pump comprising a plunger 40 and a barrel 50. Referring to FIGS. 2 and 3, the barrel 50 comprises a body end 51 and an infuser end 52. The infuser end 52 is perforated.

Referring to FIGS. 2 and 3, the barrel 50 further comprises an inside 53 and an outside 54. The plunger 40 fits tightly inside 53 the barrel 50. The plunger 40 can be pushed along the inside 53 of the barrel 50, allowing the syringe 20 to take in or expel a liquid, gas, or a combination thereof.

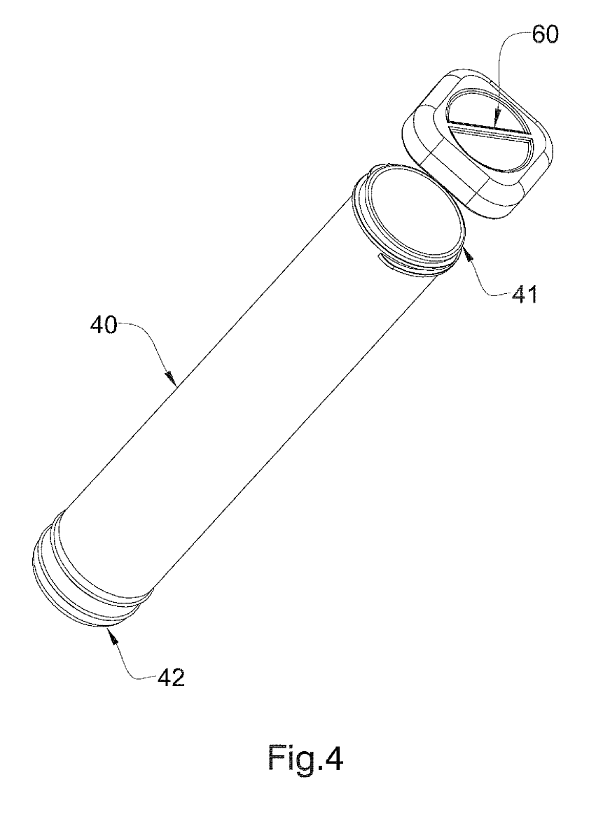

Referring to FIG. 4, in a preferred embodiment, the plunger 40 is a tube having an open end 41 and a closed end 42. The cap 60 closes the open end 41. Referring to FIGS. 1 and 3, the drip sheath 30 covers and locks securely onto the infuser end 52 of the barrel 50.The user of the press can store tea inside the plunger 40.

When ready to brew tea, the user places tea in the barrel 50, the infuser end 52 of the barrel 50 is placed in liquid, the closed end 42 of the plunger 40 is place inside the barrel 50, and the plunger 40 is pulled to take in liquid. When the user deems appropriate the liquid is expelled. To store the used tea, the plunger 40 is pushed into the barrel 50, pressing out any excess liquid, and the drip sheath 30 is secured in place to prevent left over liquid from leaking when the press is stored after use.

What is claimed:

1. A tea press comprising a syringe, drip sheath, and cap.

2. The syringe of claim 1 comprises a plunger and barrel.

3. The barrel of claim 2 comprises a body end and an infuser end.

4. The infuser end of claim 3 is perforated.

5. The barrel of claim 2 comprises an inside and an outside.

6. The plunger of claim 2 fits tightly inside the barrel.

7. The plunger of claim 6 can be pushed along the inside of the barrel allowing the syringe to take in or expel a liquid, gas, or a combination thereof.

8. The plunger of claim 6 is a tube having an open end and a closed end.

9. A cap closes the open end of the plunger in claim 8.

10. The plunger of claim 6 is solid.

11. The drip sheath of claim 1 covers and locks securely onto the infuser end of claim 3.

12. A method to use the tea press of claim 1 comprising:
a. placing tea in the barrel;
b. placing the infuser end of the barrel into liquid;
c. placing the closed end of the plunger into the barrel;
d. pulling the plunger to take in liquid;
e. expelling the liquid by pushing the plunger back into the barrel;

13. A method to store the tea press of claim 1 comprises:
a. pushing the plunger all the way into the barrel;
b. locking the drip sheath onto the infuser end of the barrel;
